(19) United States
(12) Patent Application Publication
(10) Pub. No.: US 2018/0343394 A1
(43) Pub. Date: Nov. 29, 2018

(54) ELECTRONIC APPARATUS, METHOD FOR CONTROLLING THE SAME, AND COMMUNICATION SYSTEM

(71) Applicant: CANON KABUSHIKI KAISHA, Tokyo (JP)

(72) Inventors: Yuki Nogawa, Tokyo (JP); Kazuomi Toguchi, Yokohama-shi (JP)

(21) Appl. No.: 15/963,901

(22) Filed: Apr. 26, 2018

(30) Foreign Application Priority Data
May 25, 2017 (JP) 2017-103859
Jan. 31, 2018 (JP) 2018-015727

(51) Int. Cl. H04N 5/232

(52) U.S. Cl. CPC H04N 5/23293; H04N 5/23203

(57) ABSTRACT

An electronic apparatus connected to an external apparatus through a communication terminal includes a control unit, a communication unit, and a detection unit. The control unit controls a direct current (DC) voltage level of the communication terminal. The communication unit makes communication with the external apparatus by superimposing a waveform on the DC voltage level of the communication terminal controlled by the control unit. The detection unit detects a state of the electronic apparatus. The control unit controls the DC voltage level of the communication terminal to a DC voltage level depending on the state of the electronic apparatus detected by the detection unit.

### BACKGROUND OF THE INVENTION

### Field of the Invention

The present disclosure relates to an electronic apparatus, a method for controlling the same, and a communication system.

### Description of the Related Art

A USB Type-C connector has been proposed in the USB3.1 standard. Alternate Mode is defined as an option function in the USB3.1 standard. In the Alternate Mode, image data and the like conforming to the DisplayPort (DP) standard or High-Definition Multimedia Interface (HDMI) (trademark) standard can be transferred to a display and the like. Image data is transferred in the Alternate Mode by use of a high-speed transmission line defined in the USB3.1 standard for supporting a transmission speed of 10 Gbps or more.

Further, various standards such as USB Type-C Power Delivery (PD) standard and USB Battery Charging standard are also defined in the USB3.1 standard. U. S Patent Application Publication No. 2016/0127671 discloses a technique for making image communication by connecting an apparatus including a Type-C port and an apparatus including a USB port not the Type-C port by an extension unit.

Furthermore, the roles of downstream facing port (DFP) functioning as a host and upstream facing port (UFP) functioning as a device are divided between the connected apparatuses in the USB3.1 standard. When communication is made between the connected apparatuses, the DFP apparatus transmits a query to the UFP apparatus, and the UFP apparatus transmits information in response to the reception of the query.

For example, a camera including a monitor can be connected to an electronic viewfinder by use of an interface conforming to such a standard. A circuit for generating an image for the monitor provided in the camera is common with a circuit for generating an image for the electronic viewfinder in order to reduce the circuit size. Thus, exclusive control may be performed on display of the monitor of the camera and display of the electronic viewfinder. User's approach to or separation from the electronic viewfinder may be detected and notified to the camera as a trigger of the exclusive control.

### SUMMARY OF THE INVENTION

According to an aspect of the present disclosure, an electronic apparatus connected to an external apparatus includes a communication terminal connected to the external apparatus, a control unit configured to control a direct current (DC) voltage level of the communication terminal, a communication unit configured to make communication with the external apparatus by superimposing a waveform on the DC voltage level of the communication terminal controlled by the control unit, and a detection unit configured to detect a state of the electronic apparatus, wherein the control unit controls the DC voltage level of the communication terminal to a DC voltage level depending on the state of the electronic apparatus detected by the detection unit.

Further features of the present disclosure will become apparent from the following description of embodiments (with reference to the attached drawings).

### BRIEF DESCRIPTION OF THE DRAWINGS

FIG. 1 is a perspective view illustrating an electronic apparatus and an external apparatus.

FIG. 2 is a diagram illustrating an arrangement of pins of USB Type-C connectors.

FIG. 3A is a block diagram illustrating the external apparatus.

FIG. 3B is a first block diagram illustrating the electronic apparatus.

FIG. 4 is a first time chart illustrating a temporal change in voltage value of a CC terminal.

FIG. 5 is a first flowchart illustrating data transmission between the external apparatus and the electronic apparatus.

FIG. 6 is a second flowchart illustrating operations of the external apparatus.

FIG. 7 is a second time chart illustrating operations of the electronic apparatus.

FIG. 8 is a second block diagram illustrating the electronic apparatus.

FIG. 9 is a third flowchart illustrating operations of the electronic apparatus.

FIG. 10 is a fourth flowchart illustrating operations of the external apparatus.

FIGS. 11A and 11B are second time charts illustrating data transmission between the external apparatus and the electronic apparatus.

FIG. 12 is a fifth flowchart illustrating operations of the electronic apparatus.

FIG. 13 is a third time chart illustrating data transmission between the external apparatus and the electronic apparatus.

### DESCRIPTION OF THE EMBODIMENTS

Embodiments according to the present disclosure will be described below in detail with reference to the accompanying drawings.

### First Embodiment

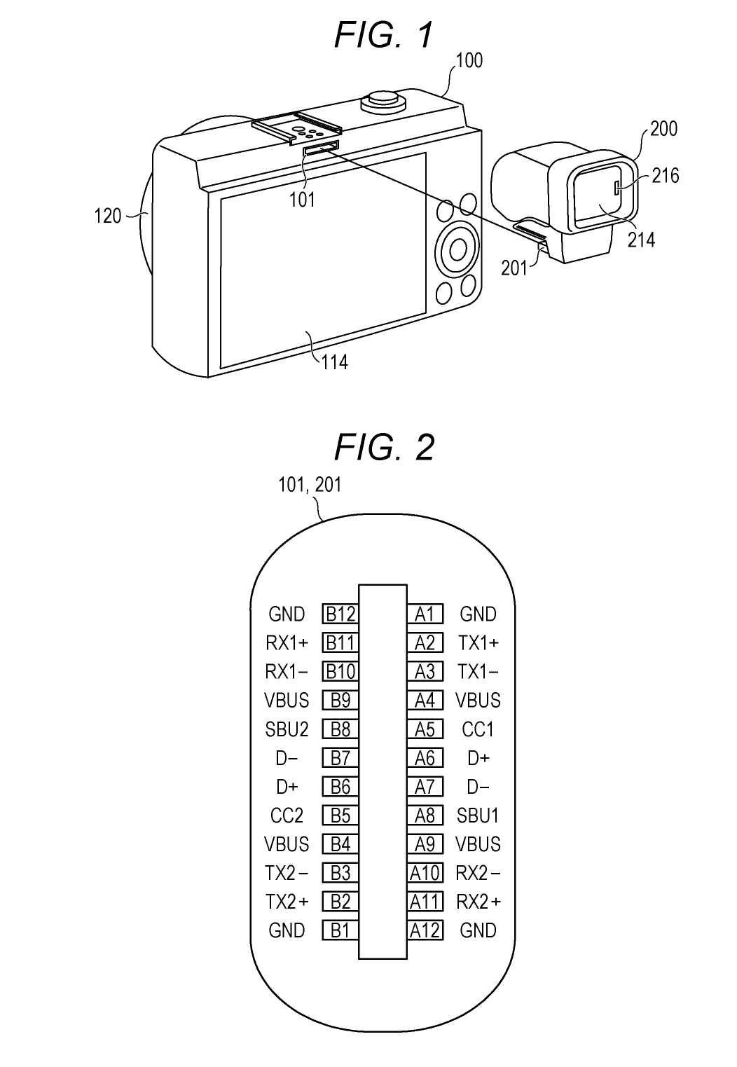

An electronic apparatus and a method for controlling the same as well as an electronic device and a method for controlling the same will be described with reference to the drawings. FIG. 1 is a perspective view illustrating an electronic apparatus and an external apparatus according to the present embodiment. The description will be made herein assuming an external apparatus 100 as a digital camera, but is not limited thereto. Further, the description will be described herein assuming an electronic apparatus 200 or electronic device as an external viewfinder attached on the digital camera, but is not limited thereto. Further, the external apparatus 100 and the electronic apparatus 200 configure a communication system for making communication at DC voltage levels of communication terminals as described below.

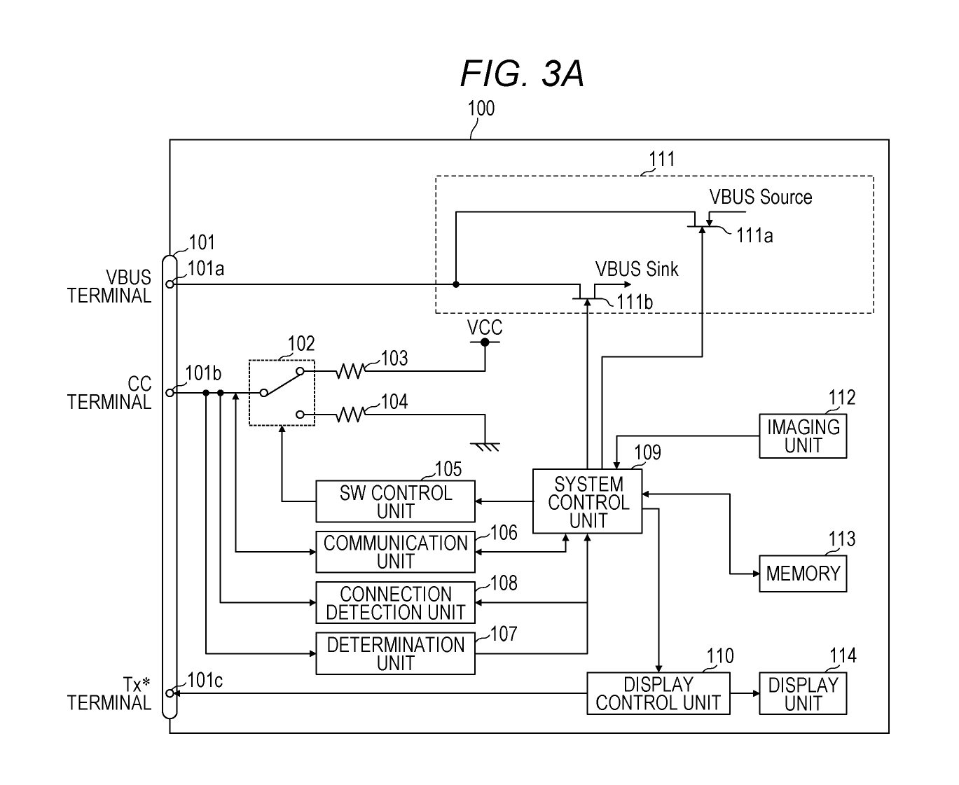

The external apparatus 100 is provided with a connector 101 for connecting to the electronic apparatus 200. The connector 101 is a receptacle conforming to the USB Type-C standard, for example. The connector 101 is connectable to the electronic apparatus 200, and can supply the electronic apparatus 200 with power. The electronic apparatus 200 is provided with a connector 201 for connecting to the external apparatus 100. The connector 201 is a plug conforming to the USB Type-C standard, for example. The connector 201 is connectable to the external apparatus 100, and can be supplied with power from the external apparatus 100. Pin assignment defined in the USB Type-C standard is applied to the connector 101 and the connector 201 as illustrated in FIG. 2.

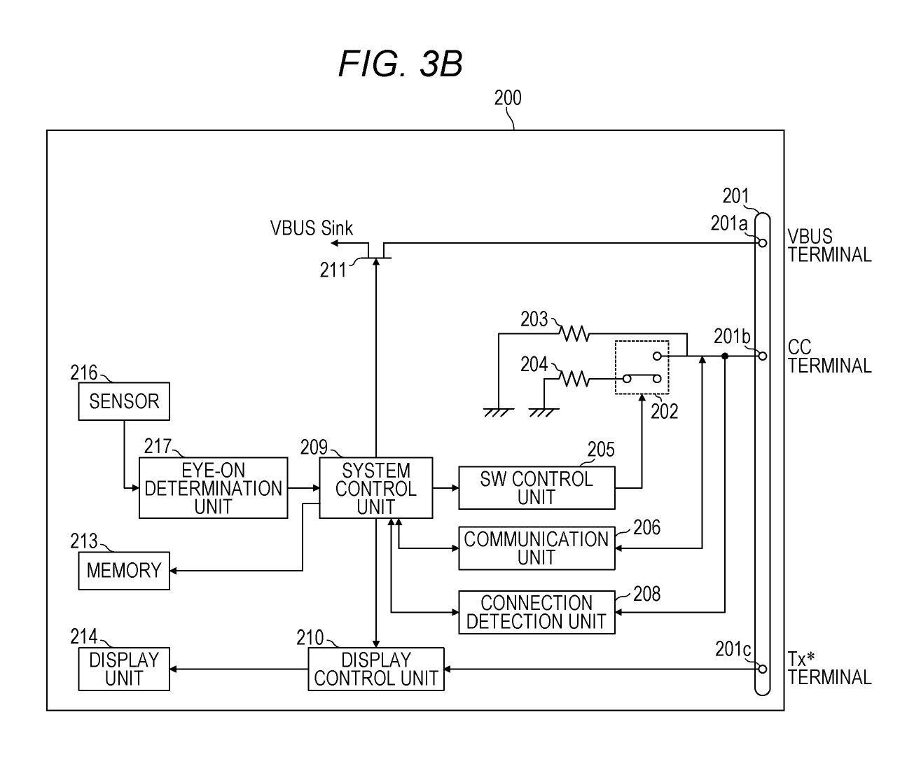

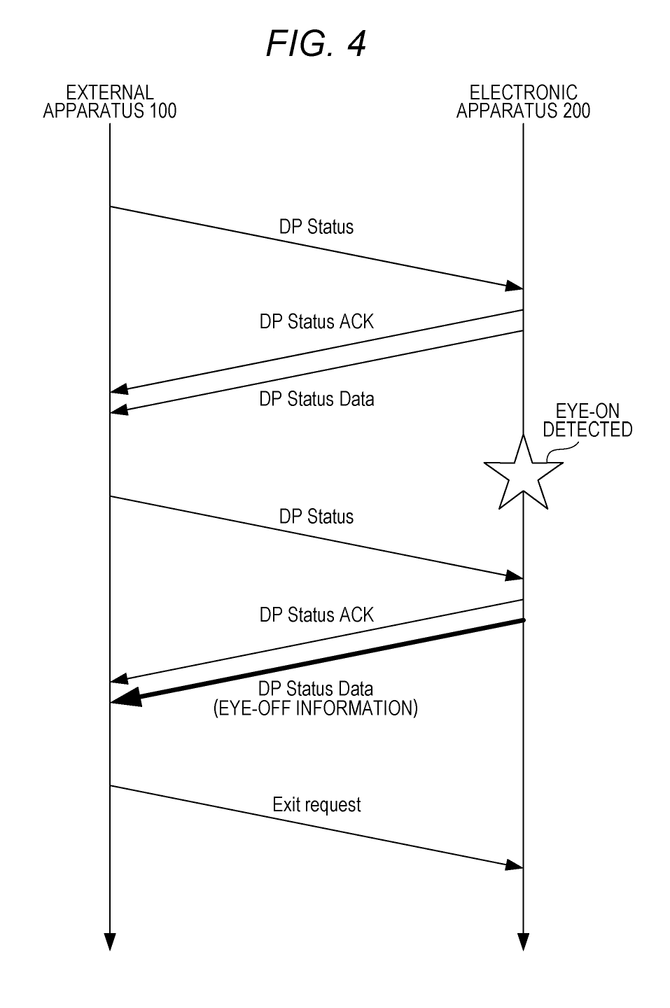

FIG. 2 is a diagram illustrating an arrangement of the pins of the USB Type-C connectors, or an arrangement of the pins of the connectors 101 and 201. The connectors 101 and 201 are provided with configuration channel (CC) terminals 101b and 201b (see FIGS. 3A and 3B) used for connection detection or negotiations, respectively. That is, the connector 101 is provided with the CC terminal (CC1, CC2) 101b. The connector 201 is provided with the CC terminal (CC1, CC2) 201b. When the connector 101 and the connector 201 are connected, the CC terminal 101b provided in the connector 101 and the CC terminal 201b provided in the connector 201 are connected to each other. A potential Vs of the CC terminal 101b is monitored by use of a connection detection unit 108 (see FIG. 3A). A potential of the CC terminal 201b is monitored by a connection detection unit 208 (see FIG. 3B). As described below, when the external apparatus 100 and the electronic apparatus 200 are connected, they can exchange information via the CC terminals. That is, the CC terminals are communication terminals for making communication.

The connector 101 is provided with a VBUS terminal (power supply terminal) 101a and a GND terminal (ground terminal). The connector 201 is provided with a VBUS terminal 201a and a GND terminal. A predetermined voltage or VBUS can be supplied from the external apparatus 100 to the electronic apparatus 200 via the VBUS terminals 101a and 201a. TX* terminals (TX1+, TX1−, TX2+, and TX2−) are signal transmission terminals, and RX* terminals (RX1+, RX1−, RX2+, and RX2−) are signal reception terminals, both of which can be used for high-speed data transmission. SBU terminals (SBU1, SBU2) are sideband signal terminals, and can be used for various applications as needed. D+ terminals and D− terminals are used for supporting USB2.0.

The external apparatus 100 is provided with an accessory shoe adaptor (accessory shoe connector). The accessory shoe adaptor serves to physically fix the electronic apparatus 200. The external apparatus 100 is provided with a display unit 114. The electronic apparatus 200 is provided with a display unit 214 different from the display unit 114 provided in the external apparatus 100. The electronic apparatus 200 includes a sensor 216. The sensor 216 is directed for detecting approach or separation of user's eye. For example, the sensor 216 is assumed as a distance measurement sensor for detecting a distance to an object approaching the electronic apparatus 200. The external apparatus 100 is provided with an imaging optical system 120 including a lens (not illustrated), or a lens unit. The imaging optical system 120 may not be detachable from the external apparatus 100 or may be detachable from the external apparatus 100.

FIGS. 3A and 3B are block diagrams illustrating the external apparatus 100 and the electronic apparatus 200 according to the present embodiment, respectively. FIG. 3A illustrates the external apparatus 100 and FIG. 3B illustrates the electronic apparatus 200.

The external apparatus 100 is provided with a port conforming to the USB Type-C standard. The port of the external apparatus 100 is provided with the connector 101. The port of the external apparatus 100 can serve as downstream facing port (DFP) and upstream facing port (UFP). That is, the port of the external apparatus 100 is assumed as a DualRole Port (DRP) as a Type-C port capable of switching the roles of DFP and UFP. Here, DFP is a port which functions as a host and supplies power, or a Source Type-C port. Further, UFP is a port which functions as a device and is supplied with power, or a Sink Type-C port.

An electronic apparatus provided with DRP, or a DRP apparatus can be a DFP apparatus which supplies power to the external apparatus, or a UFP apparatus which is supplied with power from the external apparatus. The configuration channel (CC) terminal 101b is used for determining the role of each apparatus. The port of the electronic apparatus 200 is upstream facing port (UFP), for example.

For example, the external apparatus 100 is assumed as an imaging device which operates by power supplied from a battery (not illustrated) provided in the external apparatus 100. The external apparatus 100 can transmit a video signal to the electronic apparatus 200 via a TX terminal described below. The electronic apparatus 200 is assumed as a display device which displays an image based on the video signal received from the external apparatus 100 or the like. The external apparatus 100 and the electronic apparatus 200 are not limited to the devices.

The external apparatus 100 is provided with the connector 101, specifically a receptacle as described above. The electronic apparatus 200 is provided with the connector 201, specifically a plug as described above. The connector 101 of the external apparatus 100 and the connector 201 of the electronic apparatus 200 are connected to each other. Communication can be made or power can be supplied between the port of the external apparatus 100 and the port of the electronic apparatus 200 via the connectors 101 and 201.

The external apparatus 100 includes the connector 101, a switch 102, a pull-up resistor 103, a pull-down resistor 104, a switch control unit 105, a communication unit 106, a determination unit 107, the connection detection unit 108, and a system control unit 109. The external apparatus 100 further includes a power supply unit 111, an imaging unit 112, a memory 113, the display unit 114, and an apparatus determination unit 115.

One end of the pull-up resistor 103 is connected to a power supply line. The power supply line is connected to a constant voltage power supply with a predetermined voltage, and the potential of the power supply line is set at VCC. The other end of the pull-up resistor 103 is connected to the switch 102. The pull-up resistor 103 is connectable to the CC terminal 101b via the switch 102. The resistance value of the pull-up resistor 103 is defined in the USB Type-C standard at 22 kΩ, for example. The voltage value of VCC is defined in the USB Type-C standard at 5 V, for example. VCC is generated independent of the power or VBUS supplied to the electronic apparatus 200 via the VBUS terminal 101a.

One end of the pull-down resistor 104 is connected to a ground line. The potential of the ground line is the ground potential GND or 0 V. The other end of the pull-down resistor 104 is connected to the switch 102. The pull-down resistor 104 is connectable to a predetermined terminal or the CC terminal 101b via the switch 102. The resistance value of the pull-down resistor 104 is defined in the USB Type-C standard at 5.1 kΩ, for example.

The switch 102 is directed for switching connection. The switch 102 connects the CC terminal 101b and the pull-up resistor 103 in one state (pull-up state). The switch 102 connects the CC terminal 101b and the pull-down resistor 104 in another state (pull-down state). The switch 102 connects the CC terminal 101b to neither the pull-up resistor 103 nor the pull-down resistor 104 in the other state (open state). The switch 102 is controlled by the switch control unit 105.

The switch control unit (SW control unit) 105 controls the switch 102 in response to an instruction of the system control unit 109. The switch control unit 105 can control the switch 102 such that the CC terminal 101b is connected to the pull-up resistor 103. The CC terminal 101b is connected to the pull-up resistor 103 so that the external apparatus 100 can indicate, to the electronic apparatus 200, that it is a host or DFP apparatus.

The switch control unit 105 can control the switch 102 such that the CC terminal 101b is connected to the pull-down resistor 104. The CC terminal 101b is connected to the pull-down resistor 104 so that the external apparatus 100 can indicate, to the electronic apparatus 200, that it is a device or UFP apparatus. The switch control unit 105 can periodically change over the switch 102. The switch 102 is periodically changed over so that the external apparatus 100 can indicate, to the electronic apparatus 200, that it is a DRP apparatus that can be both a host and a device.

Further, the switch control unit 105 can set the switch 102 in the open state. That is, the switch control unit 105 can set the CC terminal 101b to be connected to neither the pull-up resistor 103 nor the pull-down resistor 104. The switch control unit 105 controls such that the CC terminal 101b is alternately connected to the pull-up resistor 103 and the pull-down resistor 104 until the connection detection unit 108 determines that the external apparatus 100 and the electronic apparatus 200 are connected. Alternate and periodic connection of the CC terminal 101b to the pull-up resistor 103 and the pull-down resistor 104 is called toggling.

The communication unit 106 makes communication conforming to the USB Type-C Power Delivery (PD) standard or PD communication via the CC terminal 101b. The communication unit 106 makes communication with an apparatus connected at a modulated voltage of the CC terminal. The communication unit 106 modulates the DC voltage level of the CC terminal by superimposing a waveform thereon. Specifically, the communication unit 106 is a communication control circuit for making communication with the electronic apparatus 200 by controlling such that the voltage value of the CC terminal 101b transits to the High or Low state in a pulse manner for the DC voltage level of the CC terminal 101b. A wavelength used by the communication unit 106 for modulating the voltage of the CC terminal is not limited to the pulse-shaped waveform.

In a case that communication is made between the connected apparatuses in the Alternate Mode in the USB-Type C standard, the apparatus (the electronic apparatus 200) as a device may transmit information in response to the reception of a query from the apparatus (the external apparatus 100) as a host.

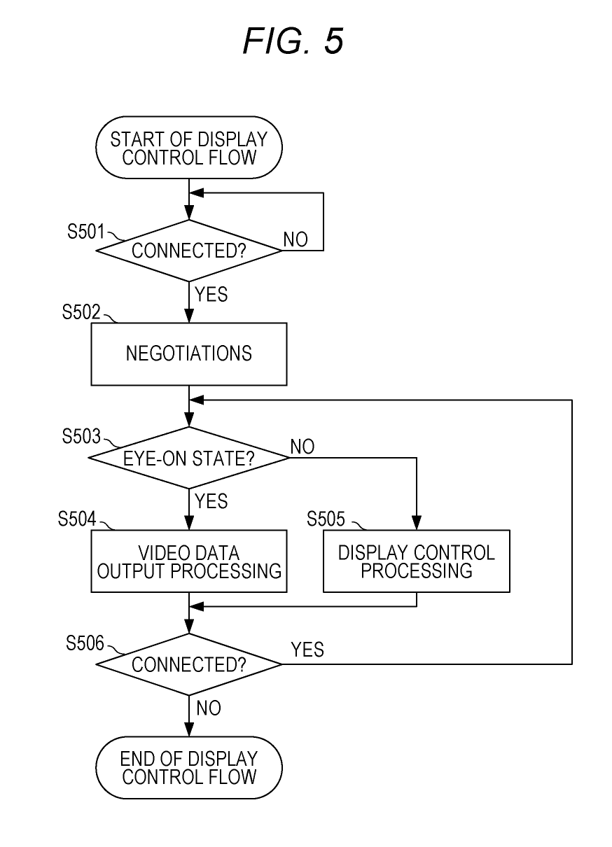

FIG. 4 is a time chart illustrating data transmission between the external apparatus 100 and the electronic apparatus 200. A query (DP Status) for requesting status information is periodically transmitted from the external apparatus 100. The external apparatus 100 transmits a query to the electronic apparatus 200 at preset intervals. For example, the external apparatus 100 transmits a query to the electronic apparatus 200 every 50 ms.

The electronic apparatus 200 returns ACK in response to the reception of the query, and subsequently transmits the status information of the electronic apparatus 200. That is, the electronic apparatus 200 transmits the information to the external apparatus 100 in response to the received query. Therefore, in a case that it is detected that the user is separated from the electronic apparatus 200 (eye-off state) at the star-marked timing in FIG. 4, the eye-off information is transmitted from the electronic apparatus 200 on the timing of transmitting the status information after the eye-off state is detected. In this case, a temporal difference (time lag) may be caused after the electronic apparatus 200 detects the eye-off state until the external apparatus 100 detects the eye-off state. A similar temporal difference is caused also in a case that the eye-on state is detected.

For example, it is assumed that the external apparatus 100 as a host transmits DP Status every 50 msec according to the Display Port standard. In this case, the electronic apparatus 200 as a device notifies the detection of the eye-on state to the external apparatus 100 up to 50 ms after the detection of the eye-on (eye-off) state.

The external apparatus 100 may display a live view image on either the display unit 114 of the external apparatus 100 or the display unit 214 of the electronic apparatus 200 depending on the eye-on state of the electronic apparatus 200. In such a case, if the above time lag is caused, the time lag in switching the display of the live view image increases, and the user may feel strangeness. Specifically, the live view image needs to be displayed on the display unit 214 when the user views the display unit 214 of the EVF (the electronic apparatus 200) (in the eye-on state). On the other hand, the live view image needs to be displayed on the display unit 114 of the digital camera (the external apparatus 100) when the user is separated from the display unit 214 of the EVF (in the eye-off state). When the user transits from the eye-on state to the eye-off state, if the live view image display is not rapidly switched, the user cannot confirm the live view immediately after the transition. This is similarly caused also in the reverse transition.

The determination unit 107 detects the voltage value of the CC terminal 101b, and determines whether the electronic apparatus 200 is in the eye-on state depending on the voltage value of the CC terminal 101b. The determination unit 107 outputs the determination result to the system control unit 109. For example, it is assumed that the DC voltage level of the CC terminal 101b is controlled to either of two voltage values depending on whether the electronic apparatus 200 is in the eye-on state. In this case, the determination unit 107 determines whether the electronic apparatus 200 is in the eye-on state depending on whether the detected DC voltage level of the CC terminal 101b is higher than a threshold assuming an average value of the two voltage values controlled by the electronic apparatus 200 as the threshold. A change in the voltage value of the CC terminal 101b depending on whether the electronic apparatus 200 is in the eye-on state will be described below.

The connection detection unit (connection detection circuit) 108 determines whether the external apparatus 100 and the electronic apparatus 200 are connected. The connection detection unit 108 outputs the determination result as to whether the external apparatus 100 and the electronic apparatus 200 are connected to the system control unit 109. That is, in a case that the external apparatus 100 and the electronic apparatus 200 are connected, the connection detection unit 108 outputs the information indicating that the external apparatus 100 and the electronic apparatus 200 are connected to the system control unit 109. In a case that the potential Vs of the CC terminal 101b is in a predetermined range indicated in the following Equation (1), the connection detection unit 108 determines that the external apparatus 100 and the electronic apparatus 200 are connected. A voltage Vmin is 0.2 V, for example, and a voltage Vmax is 2.04 V, for example. The voltages Vmin and Vmax are defined in the USB Type-C standard, for example.

Vmin≤Vs<Vmax (1)

The upper limit voltage Vmax in the predetermined range indicated in Equation (1) is lower than the potential of the power supply line connected to the pull-up resistor 103, or VCC. The lower limit voltage Vmin in the predetermined range indicated in Equation (1) is higher than the potential of the ground line connected to the pull-down resistor 104, or GND. For example, it is assumed that Vmin is 0.2 V and Vmax is 2.04 V. The voltage range in Equation (1) may be defined in the USB Type-C standard.

For example, when the CC terminal 101b is connected to the pull-up resistor 103 via the switch 102 and the external apparatus 100 and the electronic apparatus 200 are not connected, the potential Vs of the CC terminal 101b is VCC. VCC is not in the predetermined range indicated in Equation (1). In this case, the connection detection unit 108 does not determine that the external apparatus 100 and the electronic apparatus 200 are connected.

Further, when the CC terminal 101b is connected to the pull-down resistor 104 via the switch 102 and the external apparatus 100 and the electronic apparatus 200 are not connected, the potential Vs of the CC terminal 101b is GND (0 V). GND is not in the predetermined range indicated in Equation (1). In this case, the connection detection unit 108 does not determine that the external apparatus 100 and the electronic apparatus 200 are connected. In this way, in a case that the potential Vs of the CC terminal 101b is not in the predetermined range, the connection detection unit 108 does not determine that the external apparatus 100 and the electronic apparatus 200 are connected.

Even when the CC terminal 101b and the CC terminal 201b are electrically connected, if the CC terminal 101b is connected to the pull-down resistor 104, the potential Vs of the CC terminal 101b is the ground potential GND. The ground potential GND is not in the predetermined range indicated in Equation (1). In this case, the connection detection unit 108 does not determine that the external apparatus 100 and the electronic apparatus 200 are connected.

In a case that the connection detection unit 108 determines that the external apparatus 100 and the electronic apparatus 200 are connected, the system control unit 109 controls the switch control unit 105 to terminate toggling. The resistor connected to the CC terminal 101b at the end of toggling is a resistor selected by the switch control unit 105 as a resistor connected to the CC terminal 101b. In order to prevent an erroneous determination due to noise, the period in which the voltage of the CC terminal 101b meets Equation (1) needs to continue for a determination threshold or more in order to detect connection. Further, the state in which the voltage of the CC terminal 101b does not meet Equation (1) needs to be kept for the determination threshold or more in order to detect disconnection (non-connection).

According to the present embodiment, the external apparatus 100 as a DFP apparatus is assumed to be connected to the electronic apparatus 200. That is, in this case, the port of the external apparatus 100 is a source and the port of the electronic apparatus 200 is a sink. In a case that connection with the electronic apparatus 200 is established while the pull-up resistor 103 is connected to the CC terminal 101b, the external apparatus 100 enters the connected state in which it can supply power to the electronic apparatus 200 via the port.

The system control unit 109 entirely governs the external apparatus 100. The system control unit 109 controls the functional blocks provided in the external apparatus 100, or the switch control unit 105, the communication unit 106, the determination unit 107, the connection detection unit 108, the display control unit 110, and the power supply unit 111. The system control unit 109 employs a central processing unit (CPU), for example.

The system control unit 109 acquires the information output from each functional block provided in the external apparatus 100, and outputs a signal for controlling the operations of each functional block. The system control unit 109 outputs the information on whether to continue toggling to the switch control unit 105 on the basis of the determination result of the connection detection unit 108 as to whether the external apparatus 100 and the electronic apparatus 200 are connected. In a case that the connection detection unit 108 determines that the external apparatus 100 and the electronic apparatus 200 are connected, the system control unit 109 controls the switch control unit 105 to terminate toggling. Thereby, the resistor connected to the CC terminal 101b is fixed.

Further, in a case that the determination unit 107 determines that the electronic apparatus 200 is in the eye-on state, the system control unit 109 controls the display control unit 110 to output video data to the electronic apparatus 200. Furthermore, in a case that the determination unit 107 determines that the electronic apparatus 200 is in the eye-off state, the system control unit 109 controls the display control unit 110 to output video data to the display unit 114.

When displaying a video or the like on the display unit 114, the display control unit 110 controls the display unit 114 and transmits video data or the like to the display unit 114. When causing the electronic apparatus 200 to perform display in the Alternate Mode, the display control unit 110 transmits video data or the like to the electronic apparatus 200 via a TX terminal 101c of the connector 101 and an RX terminal 201c of the connector 201, for example. A destination to which the display control unit 110 outputs the video data is determined by an instruction of the system control unit 109.

In a case that the voltage of the CC terminal 101b has changed only in the first period or second period described below while the electronic apparatus 200 and the external apparatus 100 are connected, the system control unit 109 determines that the eye-on state of the electronic apparatus 200 has changed.

The power supply unit (power control circuit) 111 is provided with a voltage conversion unit (not illustrated). The voltage conversion unit generates a predetermined voltage such as VCC or VBUS by use of power supplied from a battery (not illustrated), for example. The power supply unit 111 controls supplying power to the electronic circuit or drive component provided inside the external apparatus 100. The power supply unit 111 can charge the power received from the electronic apparatus 200 in the battery. VBUS_Source indicates VBUS supplied from the external apparatus 100 to the electronic apparatus 200, and is supplied to the electronic apparatus 200 via a switch 111a and the VBUS terminal 101a. VBUS_Sink indicates VBUS supplied from the electronic apparatus 200 to the external apparatus 100, and is supplied to the battery or the like provided in the external apparatus 100.

In a case that the port of the external apparatus 100 is assumed as a source, the system control unit 109 sets the switch 111a in the ON state and a switch 111b in the OFF state. Thereby, VBUS is supplied from the external apparatus 100 to the electronic apparatus 200 via the VBUS terminal 101a. In a case that the port of the external apparatus 100 is assumed as a sink, the system control unit 109 sets the switch 111a in the OFF state and the switch 111b in the ON state. Thereby, VBUS is supplied from the electronic apparatus 200 to the external apparatus 100 via the VBUS terminal 101a.

The imaging unit 112 is provided with an imaging device (image sensor) (not illustrated). An optical image formed by the imaging optical system 120 is incident in an imaging plane (not illustrated) of the imaging device. The imaging device generates an analog image signal by photoelectrically converting the optical image, and generates a digital image signal or image data by A/D converting the analog image signal. The imaging unit 112 outputs the thus acquired image data to the system control unit 109.

The memory 113 is a storage medium for storing programs and parameters executed by the system control unit 109 for controlling each functional block.

The display unit 114 displays a still image or moving image (video) on the basis of the image data output from the display control unit 110. The display unit 114 employs a small-sized liquid crystal panel, for example. The display unit 114 is provided with a display screen exposed to the outside of the main body of the external apparatus 100, for example.

FIG. 3B is a block diagram illustrating the functional blocks of the electronic apparatus 200. The electronic apparatus 200 includes the connector 201, a switch 202, a pull-down resistor 203, a pull-down resistor 204, a switch control unit 205, a communication unit 206, the connection detection unit 208, and a system control unit 209. The electronic apparatus 200 further includes a display control unit 210, a power supply unit 211, a memory 213, the display unit 214, the sensor 216, and an eye-on determination unit 217.

The connector 201, the communication unit 206, the connection detection unit 208, the power supply unit 211, the memory 213, and the display unit 214 have the similar functions to the same functional blocks of the external apparatus 100, and thus a detailed description thereof will be omitted.

The pull-down resistor 203 is connected to the CC terminal 201b at one end and connected to a ground line at the other end, and is directed for pulling down the CC terminal 201b. The resistance value of the pull-down resistor 203 is assumed at 5.1 kΩ, for example. In a case that the electronic apparatus 200 is connected to the external apparatus 100 in the USB-Type C standard, the resistance value of the pull-down resistor 203 is not limited to the value if the voltage of the CC terminal 201b takes a resistance value meeting Equation (1).

The pull-down resistor 204 is connected to the switch 202 at one end and connected to the ground line at the other end. The pull-down resistor 204 is connected to the CC terminal 201b via the switch 202 and is directed for changing the voltage of the CC terminal 201b. The resistance value of the pull-down resistor 204 is assumed at 5.1 kΩ, for example.

The switch 202 is a switch device for switching connection and disconnection between the pull-down resistor 204 and the CC terminal 201b. The switch 202 controls connection and open depending on the eye-on state so that the DC voltage level of the CC terminal 201b is controlled to a voltage value Va indicating the eye-off state or a voltage value Vb indicating the eye-on state.

In a case that the external apparatus 100 in the USB-Type C standard and the electronic apparatus 200 are connected and the switch 202 sets the pull-down resistor 204 and the CC terminal 201b in the non-connected state, the CC terminal 201b is pulled down only by the pull-down resistor 203. It is assumed that the VCC voltage value of the external apparatus 100 is 5.0 V and the CC terminal 101b of the external apparatus 100 is connected to the pull-up resistor 103 via the switch 102. In a case that the resistance value of the pull-up resistor 103 is 22 kΩ, the voltage value Va of the CC terminal 201b is 0.94 V. This meets Equation (1).

In a case that the switch 202 sets the pull-down resistor 204 and the CC terminal 201b in the connected state, the CC terminal 201b is pulled down by the pull-down resistor 203 and the pull-down resistor 204. In this case, the CC terminal 201b is connected in parallel with the pull-down resistor 203 and the pull-down resistor 204. Thus, the voltage value Vb of the CC terminal 201b is 0.52 V. This meets Equation (1).

That is, the switch 202 can be a switch device for changing the DC voltage level of the CC terminal 201b in the voltage range of the CC terminals 101b and 201b whose connection is detected by the connection detection units 108 and 208.

The switch control unit 205 is a control circuit for controlling the connection state of the switch 202 in response to an instruction of the system control unit 209. As described above, the DC voltage level of the CC terminal 201b is determined depending on the connection state of the switch 202, and thus the switch control unit 205 can be a control circuit for controlling the DC voltage level of the CC terminal 201b.

The sensor 216 is directed for detecting approach or separation of user's eye as described above. The sensor 216 is assumed as a distance measurement sensor for detecting a distance to an object approaching the electronic apparatus 200, for example. It is assumed that in a case that an object is present within a preset distance, the sensor 216 outputs a High signal, and otherwise outputs a Low signal. The sensor 216 includes a light emitting unit for emitting an infrared ray and a light receiving unit for receiving an infrared ray reflected on a reflector or the like, for example.

The sensor 216 determines the eye-on state and the eye-off state on the basis of whether the amount of reflected light received by the light receiving unit takes a preset threshold value or more. In a case that the amount of reflected light received by the light receiving unit takes the threshold or more due to approach of a reflector such as user's face to the sensor 216, the sensor 216 determines that the electronic apparatus 200 is in the eye-on state. In a case of determining that the electronic apparatus 200 is in the eye-on state, the sensor 216 outputs the High level signal, for example, or an eye-on signal. On the other hand, in a case that a reflector such as user's face is not close to an eye-on detection unit 125 and the amount of reflected light received by the light receiving unit takes less than the threshold, the sensor 216 determines that the electronic apparatus 200 is in the eye-off state. In a case of determining that the electronic apparatus 200 is in the eye-off state, the sensor 216 outputs the Low level signal, for example, or an eye-off signal.

The eye-on determination unit 217 determines whether the electronic apparatus 200 is in the eye-on state depending on a signal output from the sensor 216. Not being in the eye-on state is being in the eye-off state. The eye-on determination unit 217 outputs the determination result to the system control unit 209. The eye-on determination unit 217 determines whether the eye-on state has transited, and outputs the determination result to the system control unit 209. Specifically, the eye-on determination unit 217 outputs the information indicating that the eye-on state has transited to the eye-off state and the information indicating that the eye-off state has transited to the eye-on state.

The system control unit 209 controls the operations of the switch control unit 205 depending on the determination result acquired from the eye-on determination unit 217. Specifically, in a case that the eye-on determination unit 217 determines that the electronic apparatus 200 is in the eye-off state, the system control unit 209 causes the switch control unit 205 to control the switch 202 such that the pull-down resistor 204 and the CC terminal 201b enter the non-connected state. Further, in a case that the eye-on determination unit 217 determines that the electronic apparatus 200 is in the eye-on state, the system control unit 209 causes the switch control unit 205 to control the switch 202 such that the pull-down resistor 204 and the CC terminal 201b enter the connected state.

The system control unit 209 may control the operations of the display control unit 210 depending on the determination result acquired from the eye-on determination unit 217. For example, in a case that the eye-on determination unit 217 determines that the electronic apparatus 200 is not in the eye-on state, the system control unit 209 may control the display control unit 210 such that power consumption of the display unit 214 is reduced. Specifically, the display control unit 210 may control such that power stops being supplied to the display unit 214 or some functions of the display unit 214 are stopped thereby to reduce power consumption. For example, in a case that the display unit 214 is a liquid crystal display module including a liquid crystal panel and a backlight, the display control unit 210 stops driving the backlight. For example, in a case that the display unit 214 is an organic EL module including an organic EL panel, the display control unit 210 may control stopping the operation of the organic EL drive power supply. Further, the display control unit 210 may control displaying an optical black image on the display unit 214.

In a case that the eye-on determination unit 217 determines that the electronic apparatus 200 is in the eye-on state, the system control unit 209 controls the display control unit 210 such that the display unit 214 can rapidly display an image based on the image data input from the external apparatus 100. Specifically, the system control unit 209 controls the display control unit 210 such that the display control unit 210 controls the display unit 214 in the stand-by state. The stand-by state is a state in which the display unit 214 can display an image based on the image data, and in a case that the display unit 214 is a liquid crystal display module, for example, the display control unit 210 drives the backlight and causes it to irradiate a light on the liquid crystal panel. The display unit 214 is controlled as described above thereby to reduce power consumption of the display unit 214.

Under the above control, the voltages of the CC terminals 101b and 201b are 0.52 V in the eye-on state. The voltages of the CC terminals 101b and 201b are 0.94 V in the eye-off state.

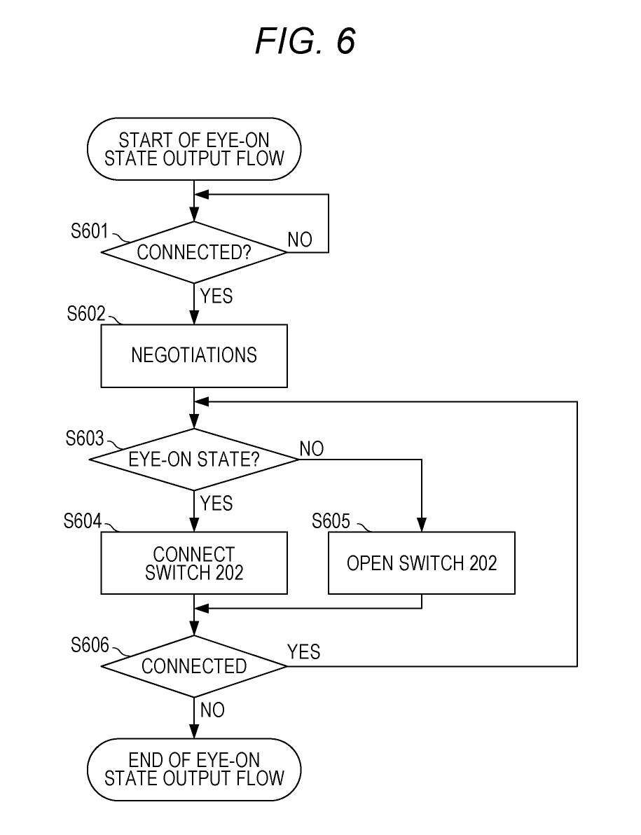

FIG. 5 is a schematic diagram illustrating a display control flow of the external apparatus 100. In S501, the connection detection unit 108 detects the voltage of the CC terminal 101b and determines whether the external apparatus 100 is connected to the electronic apparatus 200. In S501, in a case that it is determined that the external apparatus 100 is not connected to the electronic apparatus 200, the processing in S501 is repeatedly performed. In S501, in a case that it is determined that the external apparatus 100 is connected to the electronic apparatus 200, the processing proceeds to S502.

In S502, the communication unit 106 conducts negotiations with the electronic apparatus 200. The negotiations are a processing of determining whether to supply power or to be supplied with power or whether to transmit or receive a video signal between the apparatuses.

In S503, the DC voltage level of the CC terminal 101b is detected and the state of the electronic apparatus 200 is determined. Specifically, a determination is made as to whether the electronic apparatus 200 is in the eye-on state. In a case that the electronic apparatus 200 is in the eye-on state, the processing proceeds to S504. In a case that the electronic apparatus 200 is not in the eye-on state (is in the eye-off state), the processing proceeds to S505.

In S504, the display control unit 110 outputs the video data to the electronic apparatus 200 via the Tx terminal 101c. The processing proceeds to S506.

In S505, the display control unit 110 controls the display unit 114 such that the image based on the video data is displayed on the display unit 114. The processing proceeds to S506.

In S506, the connection detection unit 108 detects the voltage of the CC terminal 101b, and determines whether the external apparatus 100 is continuously being connected to the electronic apparatus 200. In a case that the connection is continued, the processing returns to S503. In a case that the connection is not continued, the processing terminates.

As described above, an influence of display switching due to a communication time lag can be restricted by detecting the state of the electronic apparatus 200 depending on the DC voltage level of the CC terminal 101b.

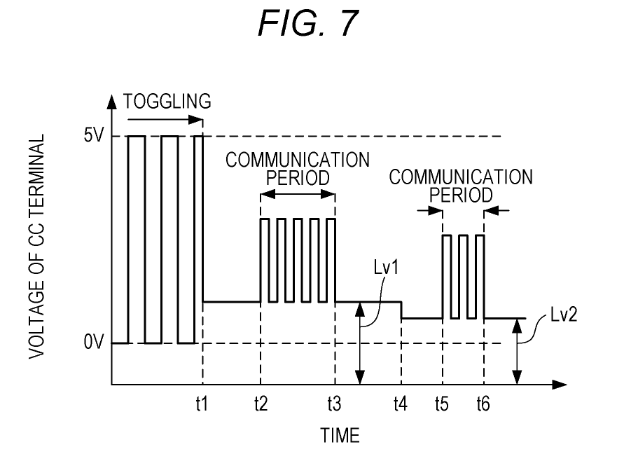

FIG. 6 is a flowchart illustrating an eye-on state output flow of the electronic apparatus 200. In S601, the connection detection unit 208 detects the voltage of the CC terminal 201b, and determines whether the electronic apparatus 200 is connected to the external apparatus 100. In S601, in a case that it is determined that the electronic apparatus 200 is not connected to the external apparatus 100, the processing in S601 is repeatedly performed. In S601, in a case that it is determined that the electronic apparatus 200 is connected to the external apparatus 100, the processing proceeds to S602.

In S602, the communication unit 206 conducts negotiations with the external apparatus 100. The negotiations are a processing of determining whether to supply power or to be supplied with power or whether to transmit or receive a video signal between the apparatuses.

In S603, the eye-on determination unit 217 determines whether the electronic apparatus 200 is in the eye-on state. In a case that it is determined that the electronic apparatus 200 is in the eye-on state, the processing proceeds to S604. In a case that it is determined that the electronic apparatus 200 is not in the eye-on state, the processing proceeds to S605.

In S604, the switch control unit 205 controls the switch 202 such that the pull-down resistor 204 is connected to the CC terminal 201b. Thereby, the DC voltage levels of the CC terminals 101b and 201b take the voltage value Vb. The processing proceeds to S606.

In S605, the switch control unit 205 controls the switch 202 such that the pull-down resistor 204 is not connected to the CC terminal 201b; in the open state. Thereby, the DC voltage levels of the CC terminals 101b and 201b take the voltage value Vb. The processing proceeds to S606.

In S606, the connection detection unit 208 detects the voltage of the CC terminal 201b, and determines whether the electronic apparatus 200 is continuously being connected to the external apparatus 100. In a case that the connection is continued, the processing returns to S603. In a case that the connection is not continued, the processing terminates.

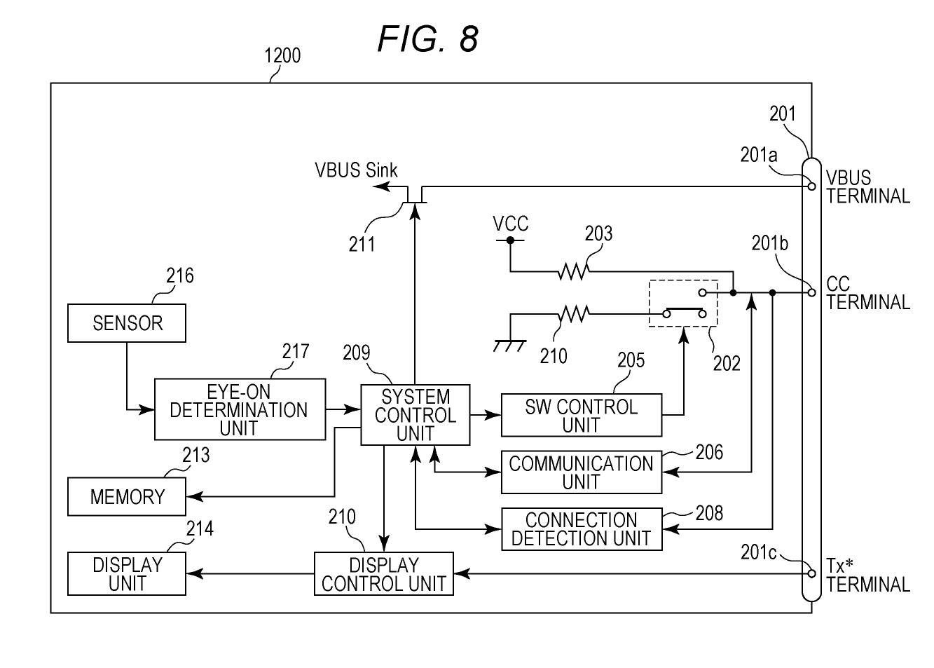

FIG. 7 is a schematic diagram illustrating a temporal change in the voltage value of the CC terminal 101b. Before the external apparatus 100 and the electronic apparatus 200 are connected, the voltage value of the CC terminal 101b periodically changes due to the toggling. In this case, the voltage value of the CC terminal 101b periodically changes to take substantially the same voltage as VCC (5 V) when connected to the pull-up resistor 103 and to take substantially the same voltage as the ground potential (0 V) when connected to the pull-down resistor 104.

The DC voltage level of the CC terminal 101b is determined in response that the external apparatus 100 and the electronic apparatus 200 are connected at timing t1. Specifically, the DC voltage level of the CC terminal 101b is a DC voltage level Lv1 depending on the pull-up resistor 103 connected to the CC terminal 101b, the VCC voltage, and the pull-down resistor connected to the CC terminal 201b. The CC terminal 201b of the electronic apparatus 200 is assumed to be connected only to the pull-down resistor 203 on connection. As described above, the DC voltage level Lv1 is assumed at 0.94 V.

The communication unit 106 conducts pulse control for making communication with the electronic apparatus 200 at timing t2. Under control of the communication unit 106, the voltages of the CC terminals 101b and 201b change for the DC voltage level in a pulse manner. The communication unit 206 of the electronic apparatus 200 can conduct similar control. When communication terminates at timing t3, the CC terminal 101b returns to the DC voltage level at timing t1.

It is assumed that the electronic apparatus 200 detects approach of an eye at timing t4. In this case, the CC terminal 201b and the pull-down resistor 204 of the electronic apparatus 200 are connected as described below. The CC terminal 201b is connected in parallel with the pull-down resistor 203 and the pull-down resistor 204, and thus the DC voltage levels of the CC terminal 201b and the CC terminal 101b lower. Specifically, the DC voltage level of the CC terminal 101b is a DC voltage level Lv2 depending on the pull-up resistor 103 connected to the CC terminal 101b, the VCC voltage, and the pull-down resistors 203 and 204 connected to the CC terminal 201b. The DC voltage level Lv2 is assumed at 0.5 V as described above. In response that the DC voltage level of the CC terminal 101b changes, the determination unit 107 can determine that the electronic apparatus 200 is in the eye-on state.

Even if the DC voltage level of the CC terminal 101b changes, the communication unit 106 conducts pulse control on the DC voltage level, thereby allowing communication between the external apparatus 100 and the electronic apparatus 200. The communication unit 106 conducts pulse control on the changed DC voltage level thereby to make communication after timing t5.

As described above, the DC voltage levels of the CC terminals 101b and 201b are controlled thereby to detect the eye-on state of the electronic apparatus 200. Thus, it is possible to detect the eye-on state of the electronic apparatus 200 and to rapidly conduct display control before (t4) the communication timing (t5) of the communication unit 106.

As described above, the DC voltage levels of the CC terminals are changed depending on the eye-on state, thereby notifying the change in the eye-on state to the external apparatus 100.

The above embodiment has been described assuming that the eye-on state is determined by use of a distance between the electronic apparatus 200 and an object detected by the sensor 216, but is not limited thereto. For example, in a case that a motion sensor is provided and the user moves the external apparatus 100 to face the screen of the display unit 214, the electronic apparatus 200 is likely to be in the eye-on state, and may be determined as being in the eye-on state. Additionally, the eye-on state detection method can be performed by use of the conventional technique.

### Second Embodiment

An electronic apparatus 1200 and a method for controlling the same as well as an electronic device and a method for controlling the same according to a second embodiment will be described with reference to the drawings. The same parts as in the first embodiment are denoted with the same reference numerals, and the description thereof will be omitted.

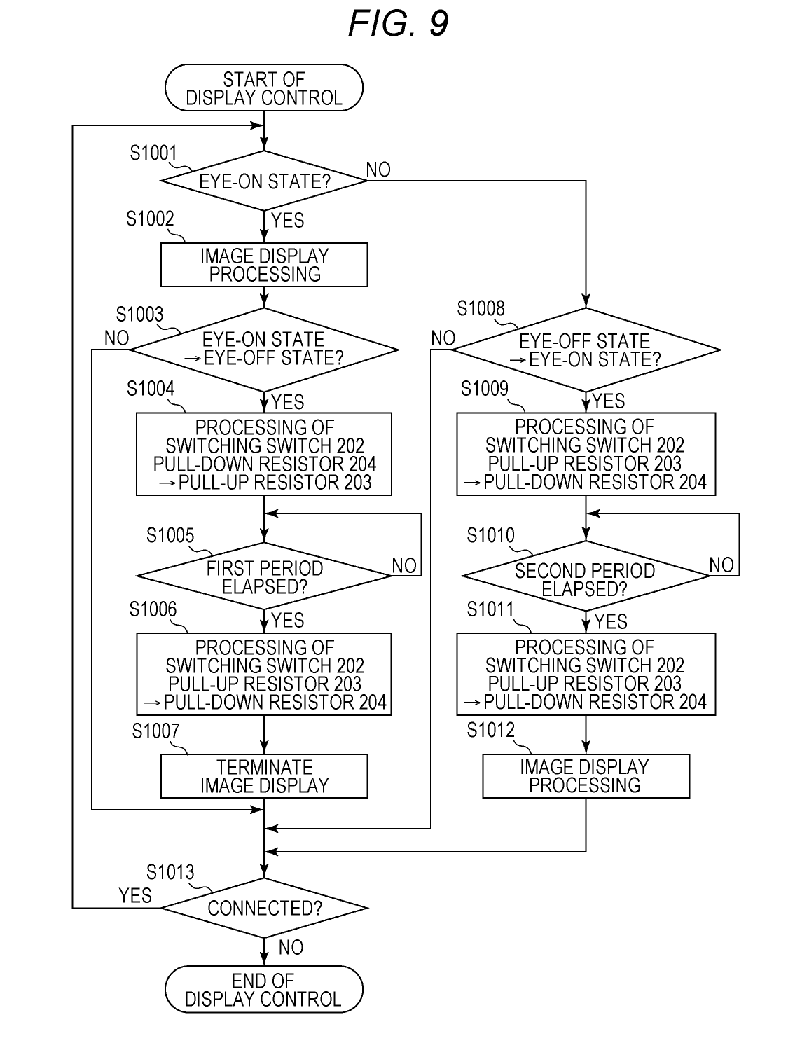

FIG. 8 is a block diagram illustrating the functional blocks of the electronic apparatus 1200. The electronic apparatus 1200 includes the connector 201, the switch 202, a pull-up resistor 210, the pull-down resistor 204, the switch control unit 205, the communication unit 206, the connection detection unit 208, and the system control unit 209. The electronic apparatus 1200 further includes the display control unit 210, the power supply unit 211, the memory 213, the display unit 214, the sensor 216, and the eye-on determination unit 217.

The connector 201, the pull-down resistor 204, the communication unit 206, the connection detection unit 208, the display control unit 210, the power supply unit 211, the memory 213, the display unit 214, the sensor 216, and the eye-on determination unit 217 have the similar functions to the same functional blocks of the electronic apparatus 200 according to the first embodiment, and thus the detailed description thereof will be omitted.

The switch control unit 205 is a control circuit for controlling the connection state of the switch 202 in response to an instruction of the system control unit 209. As described above, the DC voltage level of the CC terminal 201b is determined depending on the connection state of the switch 202, and thus the switch control unit 205 can be a control circuit for controlling the DC voltage level of the CC terminal 201b. The switch control unit 205 conducts toggling control on the switch 202 similarly to the switch control unit 105.

Further, the switch control unit 205 switches connection of the pull-up resistor 210 and the pull-down resistor 204 in order to output a signal indicating the presence of a transition of the eye-on state described below to the external apparatus 100 in response to an instruction of the system control unit 209.

The system control unit 209 controls the operations of the switch control unit 205 depending on the determination result acquired from the eye-on determination unit 217. In a case that the eye-on determination unit 217 determines that the eye-on state has transited to the eye-off state, the switch control unit 205 controls the switch 202 to switch the resistor connected to the CC terminal 201b from the pull-down resistor 204 to the pull-up resistor 210 only in the first period. Further, in a case that the eye-on determination unit 217 determines that the eye-off state has transited to the eye-on state, the switch control unit 205 controls the switch 202 to switch the resistor connected to the CC terminal 201b from the pull-down resistor 204 to the pull-up resistor 210 only in the second period. The first period and the second period may have the same duration, or may have different durations.

In a case that the connector 201 of the electronic apparatus 1200 and the connector 101 of the external apparatus 100 are connected directly or via a cable and the voltages of the CC terminals meet Equation (1), the external apparatus 100 and the electronic apparatus 1200 conduct PD negotiations. The PD negotiations are communication for adjusting the role of supplying power between the external apparatus 100 and the electronic apparatus 1200 or adjusting whether to proceed to the Alternate Mode. The communication units of the external apparatus 100 and the electronic apparatus 1200 conduct the PD negotiations via a signal line connected at the CC terminals.

According to the present embodiment, the external apparatus 100 and the electronic apparatus 1200 transit to the Alternate Mode after the PD negotiations, and enter an operation state capable of transmitting a live view image from the external apparatus 100 to the electronic apparatus 1200 via a data line.

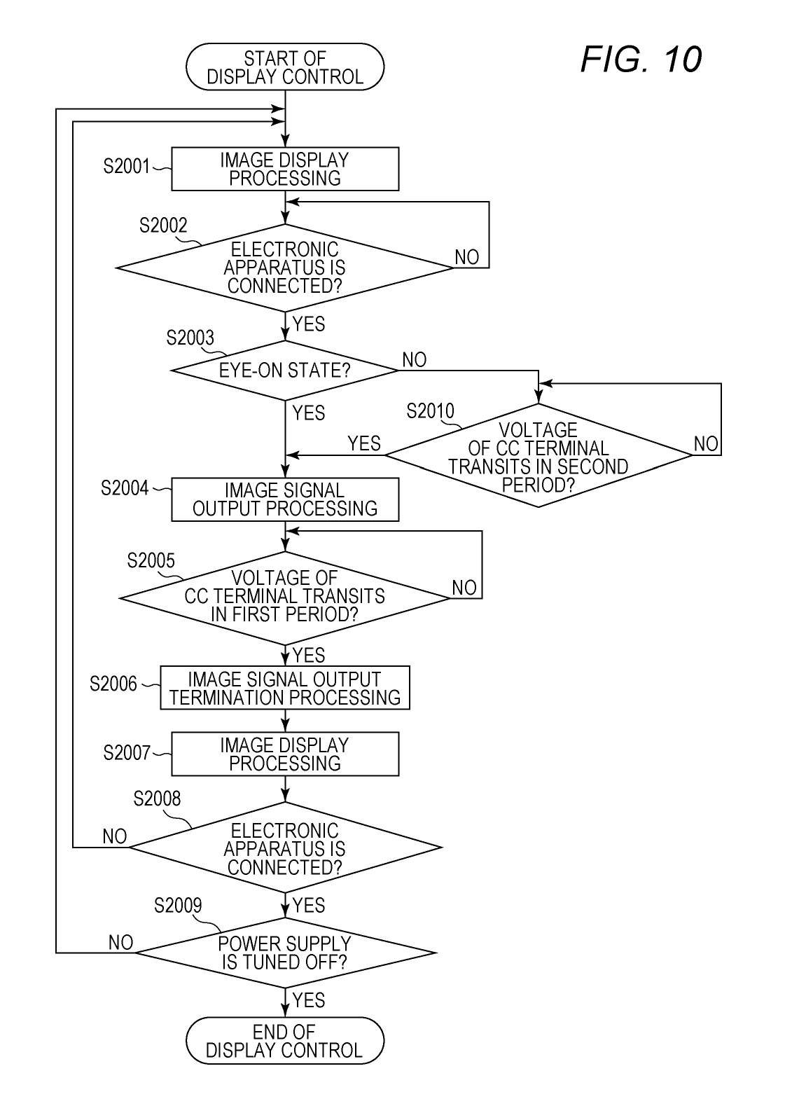

FIG. 9 is a flowchart illustrating image display control and eye-on state notification control of the electronic apparatus 1200. The flowchart starts being controlled in response that the electronic apparatus 1200 is connected to the external apparatus 100. Further, the flowchart may start being controlled in response to the power supply of the external apparatus 100 is turned on while the electronic apparatus 1200 is connected to the external apparatus 100.

In S1001, the system control unit 209 determines whether the electronic apparatus 200 is in the eye-on state on the basis of the determination result acquired from the eye-on determination unit 217. In a case that the electronic apparatus 200 is in the eye-on state (S1001, Yes), the system control unit 209 outputs the information indicating that the electronic apparatus 200 is in the eye-on state to the external apparatus 100 in PD communication via the communication unit 206, and proceeds to S1002. Further, in a case that the electronic apparatus 200 is not in the eye-on state (is in the eye-off state), the system control unit 209 outputs the information indicating that the electronic apparatus 200 is not in the eye-on state (is in the eye-off state) to the external apparatus 100 in PD communication via the communication unit 206, and proceeds to S1008.

In S1002, the system control unit 209 controls the display unit 214 to display the image by use of the video signal acquired from the external apparatus 100.

In S1003, the system control unit 209 determines whether the eye-on state has transited. Here, the system control unit 209 determines whether the eye-on state has transited to the eye-off state. In a case that the eye-on state has transited, the processing proceeds to S1004. Otherwise, the processing proceeds to S1013.

In S1004, the switch control unit 205 controls the switch 202 to change the resistor connected to the CC terminal 201b from the pull-down resistor 204 to the pull-up resistor 210 in response to an instruction of the system control unit 209.

In S1005, the system control unit 209 determines whether the first period has elapsed after the resistor connected to the CC terminal 201b is changed from the pull-down resistor 204 to the pull-up resistor 210. In a case that the first period has not elapsed, S1005 is repeatedly performed. In a case that the first period has elapsed, the processing proceeds to S1006.

In S1006, the switch control unit 205 controls the switch 202 to change the resistor connected to the CC terminal 201b from the pull-up resistor 210 to the pull-down resistor 204 in response to an instruction of the system control unit 209.

In S1007, the system control unit 209 terminates the image display processing based on the video signal acquired from the external apparatus 100.

In S1013, the system control unit 209 determines whether the electronic apparatus 1200 and the external apparatus 100 are connected. In a case that the electronic apparatus 1200 and the external apparatus 100 are not connected, the display control processing terminates. In a case that the electronic apparatus 1200 and the external apparatus 100 are connected, the processing returns to S1001.

On the other hand, in S1001, in a case that the system control unit 209 determines that the electronic apparatus 200 is not in the eye-on state, the processing proceeds to S1008. In S1008, the system control unit 209 determines whether the eye-on state has transited. Here, the system control unit 209 determines whether the eye-off state has transited to the eye-on state. In a case that it is determined that the eye-on state has transited, the processing proceeds to S1009. Otherwise, the processing proceeds to S1013.

In S1009, the switch control unit 205 controls the switch 202 to change the resistor connected to the CC terminal 201b from the pull-down resistor 204 to the pull-up resistor 210 in response to an instruction of the system control unit 209.

In S1010, the system control unit 209 determines whether the second period has elapsed after the resistor connected to the CC terminal 201b was changed from the pull-down resistor 204 to the pull-up resistor 210. In a case that the second period has not elapsed, S1010 is repeatedly performed. In a case that the second period has elapsed, the processing proceeds to S1011.

In S1011, the switch control unit 205 controls the switch 202 to change the resistor connected to the CC terminal 201b from the pull-up resistor 210 to the pull-down resistor 204 in response to an instruction of the system control unit 209.

In S1012, the system control unit 209 controls the display unit 214 to display the image by use of the video signal acquired from the external apparatus 100. The processing proceeds to S1013.

Under the above control, the electronic apparatus 1200 can output the transition of the eye-on state or the eye-on state as a pulse in a predetermined period on the voltage of the CC terminal to the external apparatus 100.

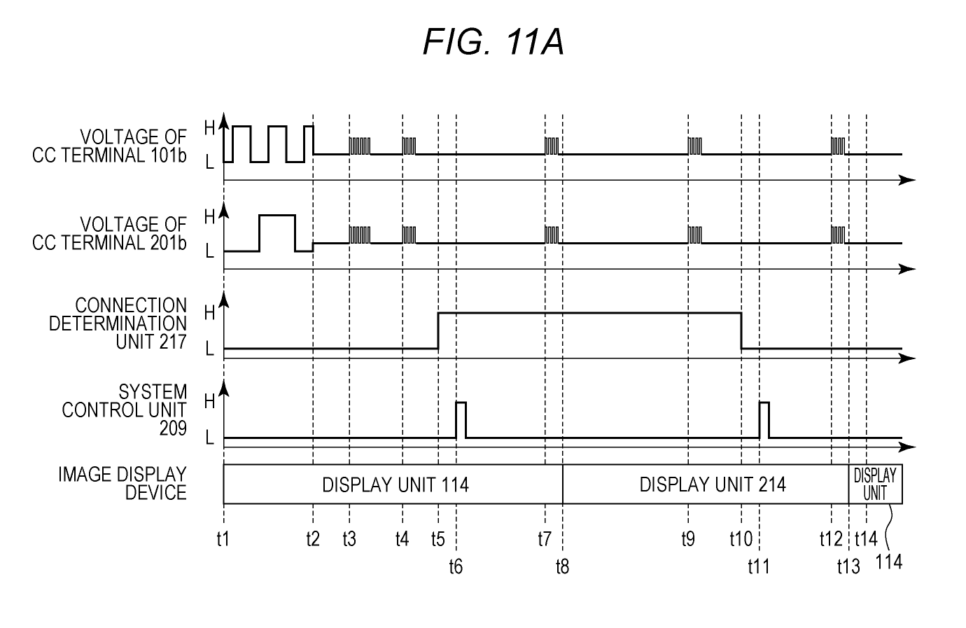

FIG. 10 is a flowchart illustrating a display control processing of the external apparatus 100. The flowchart is assumed to start in response that the power supply of the external apparatus 100 is turned on.

In S2001, the system control unit 109 controls the display unit 114 to display the image based on the video signal.

In S2002, the system control unit 109 determines whether the external apparatus 100 is connected to the electronic apparatus 1200.

In S2003, the system control unit 109 determines whether the electronic apparatus 1200 is in the eye-on state on the basis of the information acquired in PD communication via the communication unit 106. In a case that the electronic apparatus 1200 is in the eye-on state, the processing proceeds to S2004. In a case that the electronic apparatus 1200 is not in the eye-on state (is in the eye-off state), the processing proceeds to S2010.

In S2010, the system control unit 109 determines that the electronic apparatus 1200 is in the eye-off state, and keeps displaying the image on the display unit 114 of the external apparatus 100. Then in S2010, the system control unit 109 determines whether the voltage of the CC terminal 101b has changed over the second period. The system control unit 109 may determine whether a pulse for the second period has been output from the electronic apparatus 1200 to the CC terminal 101b. In a case that it is detected that the voltage of the CC terminal 101b has changed over the second period (S2010, Yes), the processing proceeds to S2004. Otherwise, the processing in S2010 is repeatedly performed.

In S2004, the system control unit 109 determines that the electronic apparatus 1200 is in the eye-on state, and performs the processing of outputting an image signal to the external apparatus 100.

In S2005, the system control unit 109 determines whether the voltage of the CC terminal 101b has changed over the first period. The system control unit 109 may determine whether a pulse for the first period has been output from the electronic apparatus 1200 to the CC terminal 101b. In a case that it is detected that the voltage of the CC terminal 101b has changed over the first period (S2005, Yes), the processing proceeds to S2006. Otherwise, the processing in S2005 is repeatedly performed.

In S2006, the system control unit 109 determines that the electronic apparatus 1200 is in the eye-off state, and stops the image signal output processing. Further in S2007, the system control unit 109 controls the display unit 114 to display the image on the display unit 114 on the basis of the image signal.

In S2008, the system control unit 109 determines whether the external apparatus 100 is connected to the electronic apparatus 1200. In a case that the external apparatus 100 is connected to the electronic apparatus 1200, the processing proceeds to S2009. Otherwise, the processing proceeds to S2001.

In S2009, the system control unit 209 determines whether an instruction of turning off the power supply has been made. The instruction of turning off the power supply is assumed to be input via an operation of an operation button or the like (not illustrated). Further, the system control unit 209 may make the instruction of turning off the power supply in response that the scanning has not been performed for a predetermined period of time. In a case that the instruction of turning off the power supply has been made, the display control processing terminates. In a case that the instruction of turning off the power supply has not been made, the processing returns to S2001.

The above processings are performed so that the external apparatus 100 can control the processing of rapidly outputting an image signal in response to a state transition of the electronic apparatus 1200.

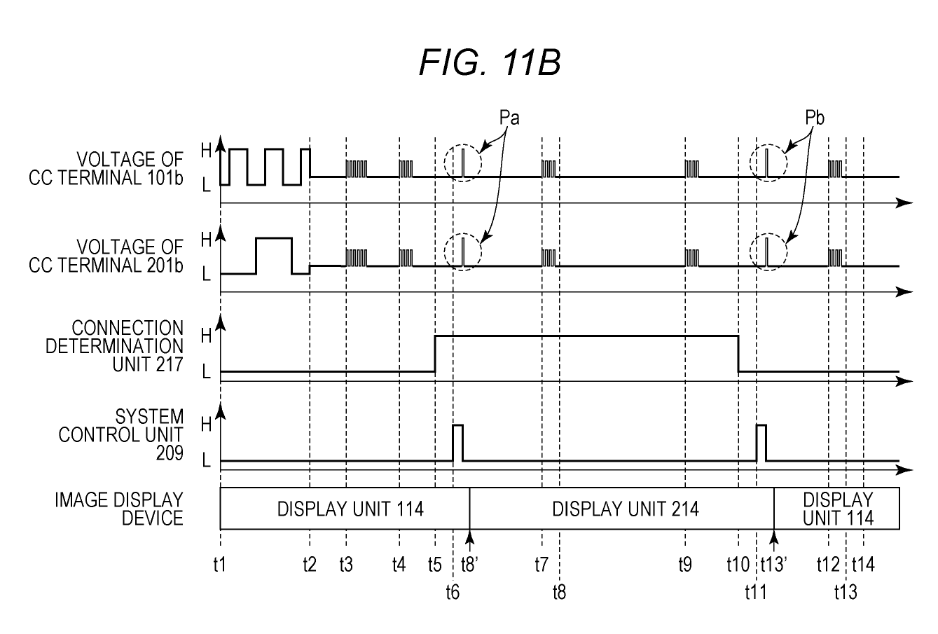

FIGS. 11A and 11B are schematic diagrams illustrating the timings of the image display processing based on a notification of the eye-on state and an image signal between the external apparatus 100 and the electronic apparatus 1200. FIG. 11A illustrates a comparative example in a case that the control according to the present embodiment is not conducted. FIG. 11B illustrates that the control according to the present embodiment is conducted.

The horizontal axis in FIGS. 11A and 11B indicates time. The external apparatus 100 and the electronic apparatus 1200 are not connected at time t1, and thus the voltages of the CC terminals thereof are periodically changed under toggling control. At this time, the electronic apparatus 1200 is in the eye-off state, and the determination result output by the eye-on determination unit 217 is Low. The image based on the image signal is displayed on the display unit 114 of the external apparatus 100.

The external apparatus 100 and the electronic apparatus 1200 are connected at time t2. The external apparatus 100 determines that connection between the external apparatus 100 and the electronic apparatus 1200 is established in response that the voltages of the CC terminals are specified as being in the predetermined voltage range until the detection period elapses after t2.

The negotiation in PD communication is started (t3) in response to determination that connection between the external apparatus 100 and the electronic apparatus 1200 is established.

After the negotiation on connection terminates, PD communication is made again at t4. The communication is directed for exchanging the information on the states of the apparatuses between the apparatuses. In FIGS. 11A and 11B, PD communication is made at t4, t7, t9, and t12. That is, this means that information can be exchanged in PD communication only at predetermined timings.

It is assumed that the electronic apparatus 1200 is in the eye-off state and the image is displayed on the display unit 114 of the external apparatus 100 during the series of processings.

At t5, the electronic apparatus 1200 is in the eye-on state, and the determination result output by the eye-on determination unit 217 is output at High.

At t6, the system control unit 209 determines that the eye-off state has transited to the eye-on state on the basis of the determination result of the eye-on determination unit 217, and outputs a control signal to output a signal indicating the eye-on state to the communication unit 206.

At t6, however, PD communication is not made, and thus the communication unit 206 waits until t7, and outputs the information indicating that the electronic apparatus 1200 is in the eye-on state to the external apparatus 100 in PD communication made at t7.

The external apparatus 100 outputs an image signal to the electronic apparatus 1200 on the basis of the information acquired in PD communication. At t8, the image based on the image signal is displayed on the display unit 214 of the electronic apparatus 1200. The period between t7 and t8 is a control period in which the external apparatus 100 switches a destination to which it outputs the image signal. It takes t8−t5 after time t5 when the eye-off state changes to the eye-on state until the device on which the image is displayed is controlled.

Further, at t10, the electronic apparatus 1200 enters the eye-off state, and the determination result output by the eye-on determination unit 217 is output at Low.

At t11, the system control unit 209 determines that the eye-on state has transited to the eye-off state on the basis of the determination result of the eye-on determination unit 217, and outputs a control signal to output a signal indicating the eye-off state to the communication unit 206.

At t11, however, PD communication is not made, and thus the communication unit 206 waits until t12, and outputs the information indicating that the electronic apparatus 1200 is in the eye-off state to the external apparatus 100 in PD communication made at t12.

The external apparatus 100 terminates the processing of outputting an image signal to the electronic apparatus 1200 on the basis of the information acquired in PD communication, and displays the image on the display unit 114 on the basis of the image signal. At t13, the image based on the image signal is displayed on the display unit 114 of the external apparatus 100. The period between t12 and t13 is a control period in which the external apparatus 100 changes a destination to which it outputs the image signal. It takes t13−t10 after time t9 when the eye-on state changes to the eye-off state until the device on which the image is displayed is controlled.

Thus, in a case that the period of PD communication is several tens ms or more, as long a delay as up to the period of PD communication is caused in display switching even if the processing speed of each apparatus is increased. This indicates that, in a case that the external apparatus 100 is a digital camera and the electronic apparatus 1200 is EVF, the period in which the user cannot confirm a live view image is prolonged due to a delay in display switching of the live view image. Therefore, there is an issue that the user misses a photo-opportunity due to a delay.

On the other hand, in a case that the processings according to the present embodiment are performed, as illustrated in FIG. 11B, the voltages of the CC terminals change only in the first period or the second period in response to a transition of the eye-on state. Thereby, the external apparatus 100 can recognize the change in the eye-on state of the electronic apparatus 1200 without waiting for a timing of PD communication.

Specifically, in a case that the system control unit 209 determines that the eye-off state has changed to the eye-on state at t6, the display device is switched at time t8′ by applying a pulse Pa to the CC terminals. In a case that the system control unit 209 determines that the eye-on state has changed to the eye-off state at t11, the display device is switched at time t13′ by applying a pulse Pb to the CC terminals.

The respective switching timings are earlier than the timings according to the comparative example. Thus, when the eye-on state of the electronic apparatus 1200 is changed, the processing of rapidly displaying an image can be changed. Therefore, the period in which the user cannot confirm a live view image can be shortened.

The display of one of the external apparatus 100 and the electronic apparatus 1200 can be stopped depending on the eye-on state, thereby reducing power consumption.

### Third Embodiment

The electronic apparatus 1200 according to the second embodiment superimposes a predetermined pulse on the CC terminal thereby to notify a state change of the electronic apparatus 1200 to the external apparatus 100. In a case that the electronic apparatus 1200 according to a third embodiment cannot detect a pulse superimposed on the CC terminal, the CC terminal is set in the non-connected potential state and thus the electronic apparatus 1200 can notify the state change to the external apparatus 100.

The configurations of the external apparatus 100 and the electronic apparatus 1200 according to the third embodiment are similar to the configurations in the second embodiment, and thus the detailed description thereof will be omitted.

According to the third embodiment, the electronic apparatus 1200 determines whether the external apparatus 100 is a predetermined kind of electronic apparatus by the apparatus determination unit 218, and switches a state change notification mode.

The apparatus determination unit 218 is directed for determining whether an external apparatus connected via the connector 201 is compatible with the electronic apparatus 1200. The compatible external apparatus is an electronic apparatus manufactured by the same vendor as the electronic apparatus 1200 and the external apparatus 100, for example, and the compatibility can be determined by receiving the information on the compatibility from the electronic apparatus 1200 via the CC terminal 201a, for example. The information on the compatibility is A Vendor ID (VID), for example. Further, the information on the compatibility is acquired in PD communication in a case that the external apparatus 100 and the electronic apparatus 1200 are connected.

In a case that the apparatus determination unit 218 determines that the connected external apparatus 100 is a compatible external apparatus, the system control unit 209 operates in the first operation mode of notifying a transition of the eye-on state under the control described in the first embodiment. In a case that the apparatus determination unit 218 determines that the connected external apparatus 100 is a compatible external apparatus, the system control unit 209 operates in the second operation mode of notifying a transition of the eye-on state under different control from the first embodiment. The compatible external apparatus is an external apparatus capable of detecting a transition of the state in the notification method described in the first embodiment.

Control in a case that a transition of the eye-on state is notified in the second operation mode will be described below in detail.

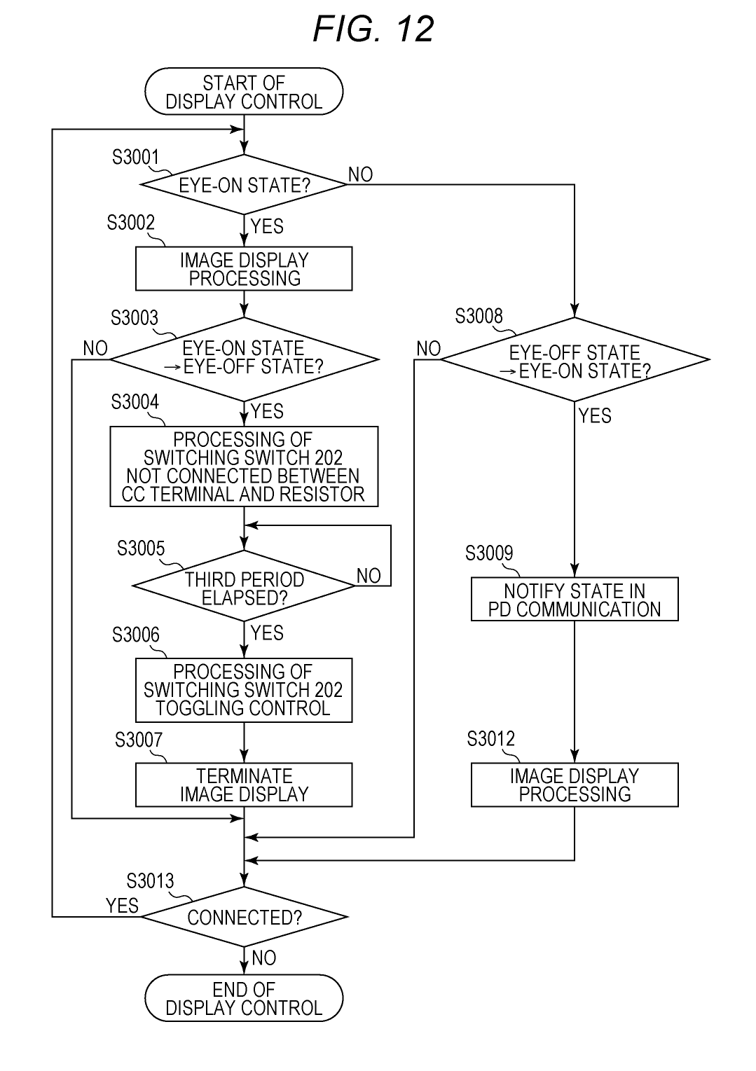

FIG. 12 is a flowchart illustrating display control and connection state notification control of the electronic apparatus 1200 in the second operation mode. S3001 to S3003, S3007, S3008, S3012, and S3013 among the processings illustrated in the flowchart of FIG. 12 are similar to S1001 to S1003, S1007, S1008, S1012, and S1013, respectively, and thus the description thereof will be omitted.

In S3003, in a case that the system control unit 209 determines that the eye-on state has changed to the eye-off state, the processing proceeds to S3004. In S3004, the switch control unit 205 controls the switch 202 to connect the CC terminal 201b to neither the pull-up resistor 210 nor the pull-down resistor 204. Thereby, the CC terminal 101b of the external apparatus 100 is connected to the power supply via the pull-up resistor 103.

In S3005, the system control unit 209 determines whether the third period has elapsed after the connection of the CC terminal 201b was changed. The third period is longer than the detection period, and is assumed at 25 ms, for example. Similarly as in S1005, the determination processing is repeatedly performed until the third period elapses.

In a case that the third period elapses, in S3006, the switch control unit 205 starts the togging control of the CC terminal 201b. In S3006, the switch control unit 205 may control the switch 202 to connect the CC terminal 201b to the pull-down resistor 204.

In S3008, in a case that the system control unit 209 determines that the eye-off state has changed to the eye-on state, in S3009, the system control unit 209 notifies the change to the eye-on state to the external apparatus 100 in PD communication. As described above, in this case, a standby time is caused after the change to the eye-on state is detected until PD communication is made.

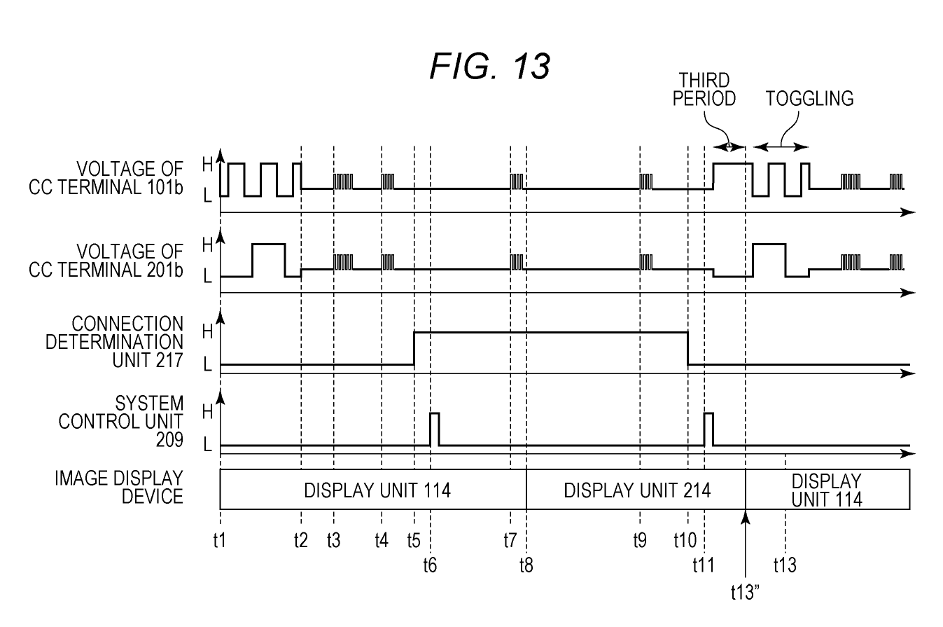

FIG. 13 is a time chart in a case that a notification is made in the second operation mode. The events between t1 and t10 are similar as in FIG. 7, and thus the description thereof will be omitted.

At t11, in a case that the system control unit 209 determines that the eye-on state has changed to the eye-off state, the switch control unit 205 causes the CC terminal 201b to connect to neither the pull-up resistor 210 nor the pull-down resistor 204 in the third period longer than the detection period. Thereby, the connection detection unit 108 of the external apparatus 100 determines that the external apparatus 100 and the electronic apparatus 1200 are not connected (are disconnected). The system control unit 109 controls such that the live view image is displayed on the display unit 114 on the basis of the detection result indicating that the external apparatus 100 and the electronic apparatus 1200 are disconnected (t13″).

Under the above control, the temporal difference (t13−t10) until the display switching, which is caused in a case that the electronic apparatus 1200 notifies a transition from the eye-on state to the eye-off state at a timing of PD communication, can be shortened.

Therefore, when the electronic apparatus 1200 changes from the eye-off state to the eye-on state, the rapid image display processing can be changed. Thus, the period in which the user cannot confirm a live view image can be shortened.

Further, the display of one of the external apparatus 100 and the electronic apparatus 1200 can be stopped depending on the eye-on state, thereby reducing power consumption.

### Other Embodiment

The present disclosure has been described above in detail by way of the embodiments, but the present disclosure is not limited to the specific embodiments, and various forms are encompassed in the present disclosure without departing from the spirit of the present disclosure.

The external apparatus 100 changes the DC voltage level of the CC terminal for the electronic apparatus 200, thereby transmitting information.

In a case that the external apparatus 100 is a digital camera and the electronic apparatus 200 is an external switch capable of conducting release control on the digital camera, a signal corresponding to the release operation performed by the user on the electronic apparatus 200 can be transmitted to the external apparatus 100 in the above method.

Further, the electronic apparatus 200 may be a smartphone or personal computer and the external apparatus 100 may be a display device such as monitor. For example, the monitor includes a sensor for detecting user's approach, and similar control can be conducted also in the communication system in which image data is transmitted from the electronic apparatus 200 in response that the user approaches the monitor. Further, the monitor includes a sensor for detecting brightness (illuminance) of the surrounding environment of the monitor and the electronic apparatus 200 may transmit image data in response that the illuminance is higher other than detecting user's approach.

The present disclosure is more useful for the external apparatus 100 and the electronic apparatus 200 which have the USB-Type C connectors conforming to the USB3.1 standard and can operate in the Alternate Mode capable of exchanging image data by use of the Tx and Rx terminals of the connectors.

The present disclosure can be realized in the processings in which a program for realizing one or more functions of the above embodiments is supplied to a system or device via a network or storage medium and one or more processors in the computer of the system or device read and execute the program. Further, the present disclosure can be realized in a circuit (such as ASIC) for realizing one or more functions.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application Nos. 2017-103859, filed May 25, 2017, and 2018-015727, filled Jan. 31, 2018 which are hereby incorporated by reference herein in their entirety.

What is claimed is:

1. An electronic apparatus connected to an external apparatus, the electronic apparatus comprising:
a communication terminal connected to the external apparatus;
a control unit configured to control a direct current (DC) voltage level of the communication terminal;
a communication unit configured to make communication with the external apparatus by superimposing a waveform on the DC voltage level of the communication terminal controlled by the control unit; and
a detection unit configured to detect a state of the electronic apparatus,
wherein the control unit controls the DC voltage level of the communication terminal to a DC voltage level depending on the state of the electronic apparatus detected by the detection unit.

2. The electronic apparatus according to claim 1, further comprising a determination unit configured to determine that the communication terminal is connected to the external apparatus in a case where the DC voltage level of the communication terminal is in a predetermined range having a first voltage level and a second voltage level different from the first voltage level,
wherein, in a case where the detection unit detects that the state of the electronic apparatus has changed, the control unit changes the DC voltage level of the communication terminal from the first voltage level to the second voltage level.

3. The electronic apparatus according to claim 2, further comprising:
a first resistor grounded at a first end; and
a second resistor grounded at a first end and having a resistance value that is different from a resistance value of the first resistor,
wherein, to control the DC voltage level of the communication terminal, the control unit switches connection between the communication terminal and either a second end of the first resistor or a second end of the second resistor.

4. The electronic apparatus according to claim 1, further comprising a determination unit configured to determine that the electronic apparatus is connected to the external apparatus in a case where the DC voltage level of the communication terminal is in a predetermined range during a predetermined detection period,
wherein, in a case where the detection unit detects that the state of the electronic apparatus has changed and only in a predetermined period shorter than the predetermined detection period, the control unit changes the DC voltage level of the communication terminal from a first voltage level to a second voltage level that is different from the first voltage level.

5. The electronic apparatus according to claim 1, comprising a display unit configured to display an image based on image data received from the external apparatus,
wherein the detection unit detects whether the electronic apparatus is in an eye-on state in which a distance between a user and the electronic apparatus is a predetermined distance or less.

6. The electronic apparatus according to claim 5, further comprising a terminal configured to receive the image data.

7. The electronic apparatus according to claim 5, further comprising a display control unit configured to control the display unit,
wherein, in a case where the detection unit does not detect the eye-on state, the display control unit controls the display unit such that an optical black image is displayed on the display unit, and
wherein, in a case where the detection unit detects the eye-on state, the display control unit controls the display unit such that an image based on the image data received from the external apparatus is displayed on the display unit.

8. The electronic apparatus according to claim 1, wherein the electronic apparatus is a viewfinder.

9. The electronic apparatus according to claim 1, wherein the communication terminal is a CC terminal defined in the USB Type-C standard conforming to the USB3.1 standard.

10. An electronic apparatus connected to an external apparatus, the electronic apparatus comprising:
a communication terminal connected to the external apparatus;
a display unit configured to display an image based on image data; and
an output unit configured to output the image data,
wherein, in a case where a first DC voltage level of the communication terminal is a first voltage level, the output unit outputs the image data to the external apparatus, and
wherein, in a case where the first DC voltage level of the communication terminal changes from the first voltage level to a second voltage level, the output unit outputs the image data to the display unit.

11. The electronic apparatus according to claim 10, wherein the electronic apparatus is a digital camera, and the external apparatus is a viewfinder.

12. A communication system comprising
a display device; and
an output device,
wherein the display device includes:
a first communication terminal,
a control unit configured to control a direct current (DC) voltage level of the first communication terminal,
a first communication control unit configured to make communication with an external apparatus by superimposing a waveform on and modulating the controlled DC voltage level of the first communication terminal,
a detection unit configured to detect a state of an electronic apparatus, and
a first display unit configured to display an image based on image data, and
the output device includes:
a second communication terminal configured to connect to the first communication terminal,
a second communication control unit configured to make communication with the electronic apparatus via the second communication terminal,
a determination unit configured to determine a state of the electronic apparatus based on a DC voltage level of the second communication terminal,
a second display unit configured to display the image based on the image data, and
an output unit configured to output the image data
wherein, in a case where the DC voltage level of the second communication terminal is a first voltage level, the output unit outputs the image data to the electronic apparatus, and
wherein, in a case where the DC voltage level of the second communication terminal is a second voltage level different from the first voltage level, the output unit outputs the image data to the second display unit.

13. A method to control an electronic apparatus connected to an external apparatus and having a communication terminal connected to the external apparatus, the method comprising:
controlling a direct current (DC) voltage level of the communication terminal;
making communication with the external apparatus by superimposing a waveform on the controlled DC voltage level of the communication terminal; and
detecting a state of the electronic apparatus,
wherein controlling includes controlling the DC voltage level of the communication terminal to a DC voltage level depending on the detected state of the electronic apparatus.

14. The method according to claim 13, further comprising determining that the communication terminal is connected to the external apparatus in a case where the DC voltage level of the communication terminal is in a predetermined range having a first voltage level and a second voltage level different from the first voltage level,
wherein, in a case where detecting includes detecting that the state of the electronic apparatus has changed, controlling includes changing the DC voltage level of the communication terminal from the first voltage level to the second voltage level.

15. The method according to claim 14,
wherein the electronic apparatus further includes a first resistor grounded at a first end, and a second resistor grounded at a first end and having a resistance value that is different from a resistance value of the first resistor,
wherein, to control the DC voltage level of the communication terminal, controlling includes switching connection between the communication terminal and either a second end of the first resistor or a second end of the second resistor.

16. The method according to claim 13, further comprising determining that the electronic apparatus is connected to the external apparatus in a case where the DC voltage level of the communication terminal is in a predetermined range during a predetermined detection period,
wherein, in a case where detecting includes detecting that the state of the electronic apparatus has changed and only in a predetermined period shorter than the predetermined detection period, controlling includes changing the DC voltage level of the communication terminal from a first voltage level to a second voltage level that is different from the first voltage level.

17. The method according to claim 13,
wherein the electronic apparatus further includes a display unit configured to display an image based on image data received from the external apparatus,
wherein detecting includes detecting whether the electronic apparatus is in an eye-on state in which a distance between a user and the electronic apparatus is a predetermined distance or less.

18. The method according to claim 17, further comprising controlling the display unit,
wherein, in a case where detecting does not include detecting the eye-on state, controlling the display unit includes controlling the display unit such that an optical black image is displayed on the display unit, and
wherein, in a case where detecting includes detecting the eye-on state, controlling the display unit includes controlling the display unit such that an image based on the image data received from the external apparatus is displayed on the display unit.

19. A method for controlling an electronic apparatus connected to an external apparatus, wherein the electronic apparatus includes a communication terminal connected to the external apparatus, the method comprising:
displaying, in a display unit, an image based on image data; and
outputting the image data,
wherein, in a case where a first DC voltage level of the communication terminal is a first voltage level, outputting includes outputting the image data to the external apparatus, and
wherein, in a case where the first DC voltage level of the communication terminal changes from the first voltage level to a second voltage level, outputting includes outputting the image data to the display unit.
